(19) United States
(12) Patent Application Publication
(10) Pub. No.: US 2024/0346343 A1
(43) Pub. Date: Oct. 17, 2024

(54) RECOMMENDATION MODEL TRAINING METHOD, ARTICLE RECOMMENDATION METHOD AND SYSTEM, AND RELATED DEVICE

(71) Applicant: Beijing Youzhuju Network Technology Co., Ltd., Beijing (CN)

(72) Inventors: Xiaoying ZHANG, Beijing (CN); Hang LI, Beijing (CN)

(21) Appl. No.: 18/747,287

(22) Filed: Jun. 18, 2024

Related U.S. Application Data
(63) Continuation of application No. PCT/CN2023/080078, filed on Mar. 7, 2023.

(30) Foreign Application Priority Data
Mar. 18, 2022 (CN) 202210268805.9

(51) Int. Cl. G06N 5/022; G06N 5/04

(52) U.S. Cl. CPC G06N 5/022; G06N 5/04

(57) ABSTRACT

The present disclosure relates to a recommendation model training method, an article recommendation method and system, and a related device. The recommendation model training method includes: processing data for training by using a recommendation model to obtain a category-independent representation and a category-dependent representation, wherein the data for training comprises a feature of a user and a feature of an article; processing the category-independent representation and the category-dependent representation respectively by using a discriminator to obtain discrimination results; determining a prediction result according to at least one of the category-independent representation or the category-dependent representation; and training the recommendation model and the discriminator according to training targets comprising the category-independent representation not corresponding to any one of the plurality of categories, the category-dependent representation corresponding to the pre-marked category, and the prediction result matching with the pre-marked recommendation information.

### CROSS-REFERENCE TO RELATED APPLICATIONS

The present application is a continuation of International Application No. PCT/CN2023/080078 filed Mar. 7, 2023, which is based on and claims the benefit of Chinese Patent Application No. 202210268805.9, filed on Mar. 18, 2022, both of the aforementioned applications are hereby incorporated by reference in their entireties.

### TECHNICAL FIELD

The invention relates to the field of data processing, in particular to a training method of a recommendation model, an article recommendation method, a system and a related device.

### BACKGROUND

In information recommendation technology, recommendation accuracy and recommendation diversity are two different objectives. Recommendation algorithms with recommendation accuracy as the main optimization objective tend to recommend popular items or items in popular category. Recommendation algorithms with recommendation diversity as the main optimization objective tend to require that the recommendation results cover as many categories as possible (diversifying across all item categories).

At present, there are three main ways to achieve the recommendation diversity.

The first category is the post-ranking algorithm represented by the Determinantal Point Process (DPP) and the Maximal Marginal Relevance (MMR), which aims at diversity and reorders the top k articles produced by the recommendation algorithm.

The second category is Learning to Rank (LTR) recommendation algorithm, which directly recommends an article list to users.

The third category is the rectification recommendation algorithm, which mainly avoids the recommendation algorithm from recommending more popular articles or articles in popular category by removing category features (Unawareness), inverse probability weighting (IPS) or removing confusion factors (DecRS).

### SUMMARY

According to a first aspect of some embodiments of the present disclosure, there is provided a training method of a recommendation model, comprising: processing data for training by using a recommendation model to obtain a category-independent representation and a category-dependent representation, wherein the data for training comprises a feature of a user and a feature of an article, and is pre-marked with recommendation information and a category of the article; processing the category-independent representation and the category-dependent representation respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories; determining a prediction result according to at least one of the category-independent representation or the category-dependent representation; and training the recommendation model and the discriminator according to training targets comprising the category-independent representation not corresponding to any one of the plurality of categories, the category-dependent representation corresponding to the pre-marked category, and the prediction result matching with the pre-marked recommendation information.

In some embodiments, a discrimination result of the discriminator has a plurality of dimensions corresponding one-to-one to the plurality of categories, and a value of each dimension of the dimensions represents a probability that a representation processed by the discriminator is related to a category corresponding to the dimension.

In some embodiments, the training the recommendation model and the discriminator comprises: determining a first loss value according to the discrimination results corresponding to the category-independent representation from the discriminator and a category-independent target result, wherein a value of each dimension in the category-independent target result is lower than a low threshold; and adjusting parameters of the recommendation model and parameters of the discriminator based on the first loss value.

In some embodiments, the determining the prediction result comprises processing the category-independent representation by using a first mapping model to obtain a first prediction result; and the training the recommendation model and the discriminator further comprises: determining a second loss value according to the first prediction result and the pre-marked recommendation information to adjust the parameters of the recommendation model, the parameters of the discriminator and parameters of the first mapping model based on the first loss value and the second loss value.

In some embodiments, the training the recommendation model and the discriminator comprises: determining a third loss value according to the discrimination result of the category-dependent representation from the discriminator and a category-dependent target result, wherein in the category-dependent target result, a value of a dimension corresponding to a pre-marked category is higher than a high threshold, and values of other dimensions are lower than a low threshold; and adjusting parameters of the recommendation model and parameters of the discriminator based on the third loss value.

In some embodiments, the determining a prediction result comprises processing the category-independent representation and the category-dependent representation by using a second mapping model to obtain a second prediction result; and the training the recommendation model and the discriminator further comprises: determining a fourth loss value according to the second prediction result and the pre-marked recommendation information to adjust the parameters of the recommendation model, the parameters of the discriminator and parameters of the second mapping model base on the third loss value and the fourth loss value.

In some embodiments, in a process of adjusting the parameters of the recommendation model, the parameters of the discriminator and the parameters of second mapping model, a value of the category-independent representation is kept constant.

In some embodiments, the recommendation information indicates whether feedback on the article is given by the user.

According to a second aspect of some embodiments of the present disclosure, there is provided an article recommendation method, comprising: processing data to be predicted by using a recommendation model to obtain a category-independent representation and a category-dependent representation, wherein the data to be predicted comprises a feature of a target user and a feature of an alternative article; determining a prediction result of the data to be predicted according to the data to be predicted; and determining whether to recommend the alternative article to the target user according to the prediction result of the data to be predicted.

In some embodiments, the alternative article is in an alternative article set, and the determining whether to recommend the alternative article to the target user comprises: determining a reference ranking of the prediction result of the data to be predicted in prediction results corresponding to all articles in the alternative article set; and recommending the alternative article to the target user in response to the reference ranking being higher than a predefined ranking.

In some embodiments, the recommendation model is trained by any training method of the recommendation model described above.

According to a third aspect of some embodiments of the present disclosure, there is provided a training apparatus of a recommendation model, comprising: a representation acquisition module configured to process data for training by using a recommendation model to obtain a category-independent representation and a category-dependent representation, wherein the data for training comprises a feature of a user and a feature of an article, and is pre-marked with recommendation information and a category of the article; a discrimination module configured to process the category-independent representation and the category-dependent representation respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories; a prediction module configured to determine a prediction result according to at least one of the category-independent representation or the category-dependent representation; and a training module configured to train the recommendation model and the discriminator according to training targets comprising the category-independent representation not corresponding to any one of the plurality of categories, the category-dependent representation corresponding to the pre-marked category, and the prediction result matching with the pre-marked recommendation information.

According to a fourth aspect of some embodiments of the present disclosure, there is provided an article recommendation apparatus, comprising: a representation acquisition module configured to process data to be predicted by using a recommendation model to obtain a category-independent representation and a category-dependent representation, wherein the data to be predicted comprises a feature of a target user and a feature of an alternative article; a prediction module configured to determine a prediction result of the data to be predicted according to the category-independent representation and the category-dependent representation of the data to be predicted; and a recommendation module configured to determine whether to recommend the alternative article to the target user according to the prediction result of the data to be predicted.

According to a fifth aspect of some embodiments of the present disclosure, there is provided an article recommendation system, comprising: the aforementioned training apparatus of the recommendation model; and the aforementioned article recommendation apparatus.

According to a sixth aspect of some embodiments of the present disclosure, there is provided an electronic device comprising: a memory; and a processor coupled to the memory, the processor being configured to perform any one of the aforementioned methods based on instructions stored in the memory.

According to a seventh aspect of some embodiments of the present disclosure, there is provided a non-transitory computer-readable storage medium, on which a computer program is stored that, when executed by a processor, implements any one of the aforementioned methods.

According to an eighth aspect of some embodiments of the present disclosure, there is provided a program comprising instructions which, when executed by a processor, cause the processor to perform any one of the aforementioned methods.

Other features and advantages of the present disclosure will become clear from the following detailed description of exemplary embodiments of the present disclosure with reference to the accompanying drawings.

### BRIEF DESCRIPTION OF THE DRAWINGS

In order to more clearly illustrate technical solutions in the embodiments of the present disclosure or the prior art, the drawings needed in the description of the embodiments or the prior art will be briefly described below. It is obvious that, the accompanying drawings in the following description are only some embodiments of the present disclosure, and for those ordinary skilled in the art, other drawings can be obtained according to these drawings without inventive labor.

FIG. 1 shows a flow diagram of a training method of a recommendation model according to some embodiments of the present disclosure.

FIG. 2 shows a flow diagram of a training method based on a category-independent representation according to some embodiments of the present disclosure.

FIG. 3 shows a flow diagram of a training method based on a category-dependent representation according to some embodiments of the present disclosure.

FIG. 4 shows a flow diagram of an article recommendation method according to some embodiments of the present disclosure.

FIG. 5 shows a schematic diagram of a data processing process during prediction.

FIG. 6 shows a schematic structural diagram of a training apparatus of a recommendation model according to some embodiments of the present disclosure.

FIG. 7 shows a structural schematic diagram of an article recommendation apparatus according to some embodiments of the present disclosure.

FIG. 8 shows a structural schematic diagram of an article recommendation system according to some embodiments of the present disclosure.

FIG. 9 shows a structural schematic diagram of an electronic device according to other embodiments of the present disclosure.

FIG. 10 shows a structural schematic diagram of an electronic device according to other embodiments of the present disclosure.

### DETAILED DESCRIPTION

In the following, the technical solution in the embodiments of the present disclosure will be clearly and completely described with reference to the drawings in the embodiments of the present disclosure. Obviously, the described embodiments are only part of the embodiments of the present application other than the whole embodiments. The following description of at least one exemplary embodiment is merely illustrative in actual and is in no way intended to limit the present application and its application or uses. Based on the embodiments in the present disclosure, all other embodiments obtained by those ordinary skilled in the art without paying inventive effort fall within the protection scope of the present disclosure.

Unless otherwise specified, the relative arrangement of components and steps, numerical expressions and numerical values set forth in these embodiments do not limit the scope of the present disclosure.

At the same time, it should be understood that for the convenience of description, the dimensions of various parts shown in the drawings are not drawn according to the actual scale relationship.

Techniques, methods and equipment known to ordinary skilled in the relevant field may not be discussed in detail, but where appropriate, such techniques, methods and equipment should be regarded as part of the authorized specification.

In all examples shown and discussed herein, any specific values should be interpreted as illustrative only and not as a limitation. Therefore, other examples of exemplary embodiments may have different values.

It should be noted that similar numbers and letters indicate similar items in the following accompanying drawings, so once an item is defined in one drawing, it does not need to be further discussed in subsequent drawings.

After analysis, the inventors find out that the recommendation algorithm with the recommendation accuracy as the main optimization objective tends to recommend more popular items or items in popular category, resulting in the deterioration of the diversity of recommendation results. Moreover, due to the existence of feedback loop, the diversity of recommendation results further deteriorates, leading to problems such as information cocoon room.

However, if we simply improve the recommendation diversity, that is, the more categories the recommendation results cover, the better, which will greatly reduce the recommendation accuracy and affect the user experience.

Therefore, a technical problem to be solved by the embodiment of the present disclosure is how to improve recommendation accuracy and recommendation diversity at the same time.

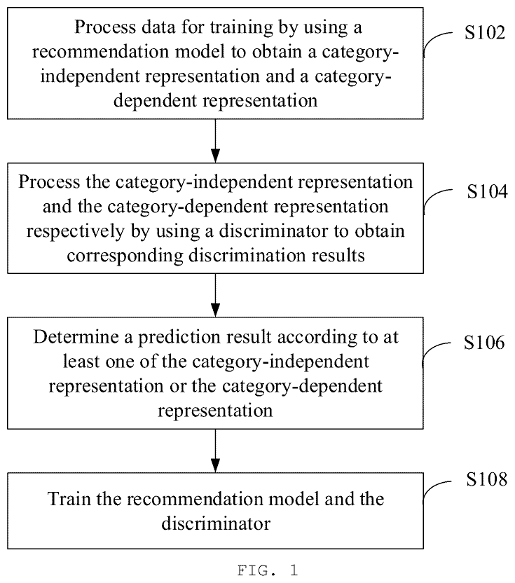

FIG. 1 shows a flow diagram of a training method of a recommendation model according to some embodiments of the present disclosure. As shown in FIG. 1, the training method of the recommendation model of this embodiment includes steps S102 to S108.

In step S102, data for training is processed by using a recommendation model to obtain a category-independent representation and a category-dependent representation, wherein the data for training comprises a feature of a user and a feature of an article, and is pre-marked with recommendation information and a category of the article.

For example, the data for training is input into the recommendation model to obtain an output representation which includes the category-independent representation and the category-dependent representation.

The output representation of the recommendation model includes the category-independent representation and the category-dependent representation. For example, multi-dimensional vectors are used to represent the output representation, and the 1st to M dimensions of the output representation represent a category-independent representation and the M+1 to N dimensions represent a category-dependent representation, or the 1st to M dimensions of the output representation represent a category-dependent representation and the M+1 to N dimensions represent a category-independent representation, where M and N are positive integers and M<N.

The category-independent representation is used to extract a representation that is common to all categories from the user feature and the article feature, so that the recommendation diversity can be improved; the category-dependent representation is used to determine the category that users are interested in, so as to improve the recommendation accuracy. Therefore, the output representation formed by the combination of the category-independent and the category-dependent can be used to recommend diversified articles from the categories that users are interested in.

In the initial stage, the output representation of the recommendation model may not be able to accurately separate the category-independent representation from the category-dependent representation. However, after the subsequent training process, the accuracy of the output representation of the recommendation model can be improved, that is, the accuracy of separating the category-independent representation from the category-dependent representation can be improved.

The data for training is pre-marked with recommendation information and the category of the article.

The recommendation information indicates whether to recommend an article to the user. In some embodiments, the recommendation information indicates whether the user gives feedback on the article, the feedback including, for example, clicking on the article, favouriting the article or purchasing the article, etc. For example, if the user gives feedback on the article, a 1 mark is used; if the user does not give feedback on the article, a 0 mark is used.

When marking the training data, the recommendation information can be determined according to the known feedback of users to the article, for example, according to the historical data, browsing data or operation data of the users on the e-commerce platform. Articles can be not only the articles of e-commerce platform, that is, physical articles, but also virtual articles such as essays, music and movies in websites or applications.

In step S104, the category-independent representation and the category-dependent representation are processed respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories.

For example, the category-independent representation and the category-dependent representation are respectively input into the discriminator to obtain the corresponding discrimination results.

In response to the discrimination result indicating that a correlation between a representation processed by the discriminator and each category is very low (for example, the correlation is lower than the lower limit or the correlation is 0), it can be determined that the representation does not correspond to any category; in response to the discrimination result indicating that a representation processed by the discriminator has a certain correlation with at least some categories (for example, the correlation is higher than the upper limit or the correlation is not 0), one or more categories with the highest correlation can be determined as the category corresponding to the representation.

In some embodiments, a discrimination result of the discriminator has a plurality of dimensions corresponding one-to-one to the plurality of categories, and a value of each dimension of the dimensions represents a probability that a representation processed by the discriminator is related to a category corresponding to the dimension. For example, if there are C article categories, the discrimination result of the discriminator can be a vector with C dimensions.

In step S106, a prediction result is determined according to at least one of the category-independent representation or the category-dependent representation.

In some embodiments, a mapping model is used to obtain a prediction result. The mapping model is, for example, a fully connected layer, which is used to map data of multiple dimensions into numerical values.

The prediction result corresponds to the pre-marked recommendation information and is configured to indicate a recommendation degree of recommending an article to a user. For example, suppose that the recommendation information indicates whether the user gives feedback to the article, and if the user gives feedback to the article, a 1 mark is used; if the user does not give feedback on the article, a 0 mark is used. Then the prediction result can indicate a probability that the user gives feedback to the article, and the greater the probability, the higher the recommendation degree.

In some embodiments, during training based on the category-independent representation, the prediction result is determined according to the category-independent representation. For example, a category-independent representation is input into a first mapping model to obtain a first prediction result, wherein the number of dimensions of the input data of the first mapping model is equal to the number of dimensions of the category-independent representation.

In some embodiments, during training based on the category-dependent representation, the prediction result is determined according to the category-independent representation and the category-dependent representation. For example, the output representation of the recommendation model (including the category-independent representation and the category-dependent representation) is input into a second mapping model to obtain a second prediction result, wherein the number of dimensions of the input data of the second mapping model is equal to the sum of the number of dimensions of the category-independent representation and the category-dependent representation, that is, equal to the number of dimensions of the output representation of the recommendation model.

In step S108, the recommendation model and the discriminator are trained according to training targets comprising the category-independent representation not corresponding to any one of the plurality of categories, the category-dependent representation corresponding to the pre-marked category, and the prediction result matching with the pre-marked recommendation information.

For example, a loss value is determined based on the training target, and the parameters of the recommendation model and the parameters of the discriminator are adjusted by the back propagation algorithm.

The above training process is based on an adversarial learning method. The training process can be performed iteratively. For example, after adjusting the parameters of the recommendation model and the parameters of the discriminator based on the above training objectives by using a batch of training data, the prediction accuracy of both the recommendation model and the discriminator is improved. When the discriminator can more accurately determine the correlation between the processed representation and the categories, it can make the recommendation model more accurately separate the category-dependent representation from the category-independent representation in the process of adjusting the parameters using the next batch of training data, so that the prediction effect of the recommendation model is also improved.

In the above embodiment, when the recommendation model outputs the representation, it is trained based on the objective of separating the category-independent representation from the category-dependent representation, which can improve the recommendation diversity and accuracy of the recommendation model at the same time. This process does not add extra complexity, nor does it introduce noise irrelevant to users and articles, and makes full use of the important information of article category, so it has a good training effect.

The following describes the training method after obtaining the category-independent representation and the category-dependent representation based on the category-independent representation and the category-dependent representation respectively.

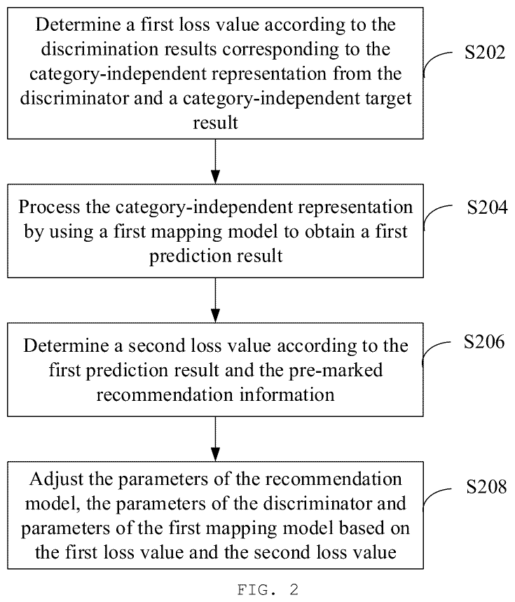

FIG. 2 shows a flow diagram of a training method based on a category-independent representation according to some embodiments of the present disclosure. As shown in FIG. 2, the training method of this embodiment includes steps S202 to S208.

In step S202, a first loss value is determined according to the discrimination results corresponding to the category-independent representation from the discriminator and a category-independent target result, wherein a value of each dimension in the category-independent target result is lower than a low threshold.

For example, the category-independent target result is (0, 0, . . . , 0), that is, the ideal situation is that the category-independent representation is not related to each category. Then, the first loss value can be determined according to a difference between the discrimination result and the category-independent target result and measured, for example, by cross entropy.

Then, the first loss value can be used to adjust the parameters of the recommendation model and the parameters of the discriminator.

By using the first loss value to adjust the parameters of the recommendation model and the parameters of the discriminator, on the one hand, the recommendation model can more accurately separate the category-independent representation, on the other hand, the accuracy of the discriminator in identifying the correlation between the input representation and the category is also improved.

In some embodiments, parameter adjustment is also combined with the prediction accuracy of the recommendation model, for example, it is implemented through steps S204 to S208.

In step S204, the category-independent representation is processed by using a first mapping model to obtain a first prediction result. For example, the category-independent representation is input to the first mapping model.

In some embodiments, the number of dimensions of the input data of the first mapping model is equal to the number of dimensions of the category-independent representation. The first mapping model is, for example, a first fully connected layer.

In step S206, a second loss value is determined according to the first prediction result and the pre-marked recommendation information.

For example, a cross entropy of the first prediction result and the pre-marked recommendation information is calculated to obtain the second loss value.

In step S208, the parameters of the recommendation model, the parameters of the discriminator and parameters of the first mapping model are adjusted based on the first loss value and the second loss value.

The above-mentioned embodiment uses the first loss value and the second loss value to adjust the parameters of the recommendation model, the discriminator and the first mapping model, that is, the training is conducted through two optimization objectives. The first optimization objective is that the discriminator determines that the category-independent representation is not related to any one of the plurality of categories, and the second optimization objective is that the recommendation model can be used to correctly predict the recommendation information, such as the user's feedback on articles. Therefore, the accuracy of the discriminator and the recommendation model can be improved. Moreover, in the training process, the parameters of the first mapping model are constantly optimized, so as to help get better training results in the iterative training process.

FIG. 3 shows a flow diagram of a training method based on a category-dependent representation according to some embodiments of the present disclosure. As shown in FIG. 3, the training method of this embodiment includes steps S302 to S308.

In step S302, a third loss value is determined according to the discrimination result of the category-dependent representation from the discriminator and a category-dependent target result, wherein in the category-dependent target result, a value of a dimension corresponding to a pre-marked category is higher than a high threshold, and values of other dimensions are lower than a low threshold.

For example, the first dimension, the second dimension . . . of the output result of the discriminator are set to respectively correspond to the first category, the second category . . . among a plurality of categories. If the pre-marked articles belong to the first category, the category-dependent target result is (1, 0, . . . , 0), that is, an ideal situation is that the category-dependent representation is related to the first category and not related to other categories. Then, the third loss value can be determined according to a difference between the discrimination result and the category-dependent target result and measured, for example, by cross entropy.

Then, the parameters of the recommendation model and the discriminator can be adjusted based on the third loss value.

By using the third loss value to adjust the parameters of the recommendation model and the parameters of the discriminator, on the one hand, the recommendation model can more accurately separate the category-dependent representation, on the other hand, the accuracy of the discriminator in identifying the correlation between the input representation and the categories is also improved.

In some embodiments, the parameter adjustment is also combined with the prediction accuracy of the recommendation model, for example, it is implemented through steps S304 to S308.

In step S304, the category-independent representation and the category-dependent representation are processed by using a second mapping model to obtain a second prediction result. For example, a representation consisting of the category-independent representation and the category-dependent representation is input to the second mapping model.

In some embodiments, the number of dimensions of the input data of the second mapping model is equal to the number of dimensions of the representation consisting of the category-independent representation and the category-dependent representation. The second mapping model is, for example, a second fully connected layer.

In step S306, a fourth loss value is determined according to the second prediction result and the pre-marked recommendation information.

For example, a cross entropy of the second prediction result and the pre-marked recommendation information is calculated to obtain the fourth loss value.

In step S308, the parameters of the recommendation model, the parameters of the discriminator and parameters of the second mapping model are adjusted base on the third loss value and the fourth loss value.

In some embodiments, in the process of adjusting the parameters of the recommendation model, the parameters of the discriminator and the second mapping model, the value of the category-independent representation is kept constant. For example, in the process of gradient descent, the value of category-independent representation is kept unchanged, thus avoiding the influence of category-independent representation on the optimization process corresponding to category-dependent representation.

The above embodiment uses the third loss value and the fourth loss value to adjust the parameters of the recommendation model, the parameters of the discriminator and the parameters of the second mapping model, that is, the training is conducted through two optimization objectives. The first optimization objective is that the discriminator can correctly predict the category corresponding to the category-dependent representation, and the second optimization objective is that the recommendation model can be used to correctly predict the recommendation information, such as the user's feedback on the article. Therefore, the accuracy of the discriminator and the recommendation model can be improved. Moreover, in the training process, the parameters of the second mapping model are constantly optimized, so as to help get better training results in the iterative training process.

The inventors conducted a test by using the method of the above embodiments. Tables 1 to 3 exemplarily show the test results. In the test, the data sets ML-1M (MovieLens 1M data set), ML-10M (MovieLens 10M data set) and Amazon-Books (Amazon books data set) were used respectively, and for each data set, NFM, Unawareness, IPS, DecRS algorithms and the method of the present disclosure were used. The evaluation indexes include AUC (Area Under Curve, area under ROC curve), UAUC (average AUC on user side), Relalmpr (relative improvement) and CE@5 (category entropy of the top five).

TABLE 1

| | | | | |
|---|---|---|---|---|
| Method | AUC | UAUC | Relalmpr | CE@5 |

ML- 1M

| | | | | |
|---|---|---|---|---|
| NFM | 0.8026 | 0.7225 | 0.00% | 1.5741 |
| Unawareness | 0.7963 | 0.7113 | −5.03% | 1.7682 |
| IPS | 0.8012 | 0.7189 | −1.62% | 1.6201 |
| DecRS | 0.8057 | 0.7253 | 1.26% | 1.5018 |
| Method of the | 0.8067 | 0.7298 | 3.28% | 1.647 |
| Present | | | | |
| Disclosure | | | | |

ML- 10M

| | | | | |
|---|---|---|---|---|
| NFM | 0.8060 | 0.7385 | 0.00% | 1.6029 |
| Unawareness | 0.7969 | 0.7275 | −4.61% | 1.739 |
| IPS | 0.7996 | 0.7290 | −3.98% | 1.4765 |
| DecRS | 0.8063 | 0.7386 | 0.04% | 1.5725 |
| Method of the | 0.8068 | 0.7411 | 1.09% | 1.6089 |
| Present | | | | |
| Disclosure | | | | |

Amazon-Books

| | | | | |
|---|---|---|---|---|
| NFM | 0.7479 | 0.6101 | 0.00% | 1..6032 |
| Unawareness | 0.7127 | 0.5696 | −36.7% | 1.838 |
| IPS | 0.7468 | 0.6064 | −3.36% | 1.6548 |
| DecRS | 0.7533 | 0.6107 | 0.54% | 1.6 |
| Method of the | 0.7548 | 0.6136 | 3.18% | 1.6731 |
| Present | | | | |
| Disclosure | | | | |

From the results of the evaluation indexes in Table 1, it can be seen that the method of the present disclosure can improve the recommendation accuracy and diversity at the same time.

TABLE 2

| | | | | |
|---|---|---|---|---|
| Category | Method | AUC | UAUC | RelaImpr |

ML-1M

| | | | | |
|---|---|---|---|---|
| Category 1 | NEM | 0.7624 | 0.6988 | 0.00% |
| | DecRS | 0.7644 | 0.7037 | 2.46% |
| | Method of the | 0.7679 | 0.7069 | 4.07% |
| | Present | | | |
| | Disclosure | | | |
| Category 2 | NFM | 0.7419 | 0.6750 | 0.00% |
| | DecRS | 0.7434 | 0.6795 | 2.57% |
| | Method of the | 0.7437 | 0.6812 | 3.54% |
| | Present | | | |
| | Disclosure | | | |
| Category 3 | NEM | 0.7279 | 0.6860 | 0.00% |
| | DecRS | 0.7310 | 0.6881 | 1.13% |
| | Method of the | 0.7334 | 0.6917 | 3.06% |
| | Present | | | |
| | Disclosure | | | |

ML-10M

| | | | | |
|---|---|---|---|---|
| Category 1 | NEM | 0.7442 | 0.6843 | 0.00% |
| | DecRS | 0.7463 | 0.6888 | 2.44% |
| | Method of the | 0.7469 | 0.6891 | 2.60% |
| | Present | | | |
| | Disclosure | | | |
| Category 2 | NFM | 0.7835 | 0.7351 | 0.00% |
| | DecRS | 0.7826 | 0.7319 | −1.36% |
| | Method of the | 0.7846 | 0.7388 | 1.57% |
| | Present | | | |
| | Disclosure | | | |
| Category 3 | NFM | 0.7707 | 0.7270 | 0.00% |
| | DecRS | 0.7694 | 0.7274 | 0.18% |
| | Method of the | 0.7743 | 0.7373 | 4.54% |
| | Present | | | |
| | Disclosure | | | |

Amazon-Books

| | | | | |
|---|---|---|---|---|
| Category 1 | NFM | 0.6474 | 0.5698 | 0.00% |
| | DecRS | 0.6523 | 0.5766 | 9.74% |
| | Method of the | 0.6564 | 0.5812 | 16.33% |
| | Present | | | |
| | Disclosure | | | |
| Category 2 | NFM | 0.7047 | 0.6493 | 0.00% |
| | DecRS | 0.7083 | 0.6369 | −8.30% |
| | Method of the | 0.7063 | 0.6505 | 0.83% |
| | Present | | | |
| | Disclosure | | | |
| Category 3 | NFM | 0.6891 | 0.6060 | 0.00% |
| | DecRS | 0.6885 | 0.5920 | −13.20% |
| | Method of the | 0.6924 | 0.6051 | −0.85% |
| | Present | | | |
| | Disclosure | | | |

It can be seen from the values of the evaluation indexes in Table 2 that the present disclosure can better capture the preferences of users for articles in the same category.

TABLE 3

| | ML-1M | | ML-10M | | Amazon-Books | |
|---|---|---|---|---|---|---|
| Method | UAUC | RelaImpr | UAUC | Relalmpr | UAUC | RelaImpr |
| NEM DecRS | 0.7263 | 0.00% | 0.7452 | 0.00%-0.04% | 0.6167 | 0.00% |
| | 0.7312 | 2.16% | 0.7451 | | 0.6206 | 3.34% |
| Method of | 0.7320 | 2.52% | 0.7492 | 1.63% | 0.6241 | 6.34% |
| the Present | | | | | | |
| Disclosure | | | | | | |

Table 3 is the test results of recommendation of articles of categories that users have not seen. From the values of the evaluation indexes in Table 3, it can be seen that the method of the present disclosure can better predict the user's preference for unseen categories.

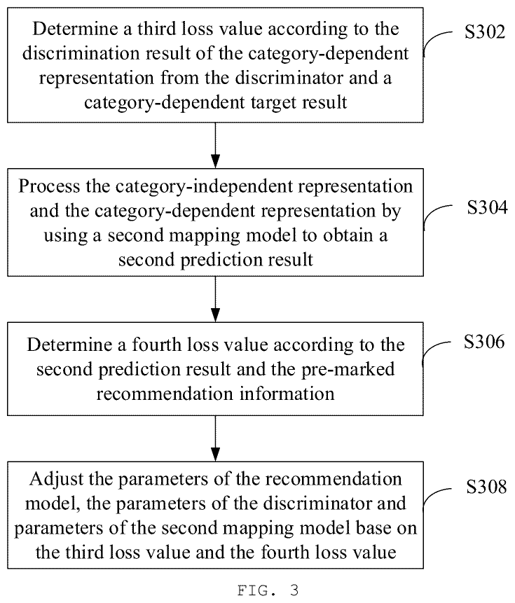

An embodiment of the article recommendation method of the present disclosure is described below with reference to FIG. 4.

FIG. 4 shows a flow diagram of an article recommendation method according to some embodiments of the present disclosure. As shown in FIG. 4, the article recommendation method of this embodiment includes steps S402 to S406.

In step S402, data to be predicted is processed by using a recommendation model to obtain a category-independent representation and a category-dependent representation, wherein the data to be predicted comprises a feature of a target user and a feature of an alternative article.

For example, the data to be predicted is input into the recommendation model to obtain output representation, which include the category-independent representation and the category-dependent representation.

In some embodiments, the feature of the target user and the feature of the alternative article are read from a database, for example.

In step S404, a prediction result of the data to be predicted is determined according to the data to be predicted.

In some embodiments, a mapping model is used to process the data to be predicted to determine the prediction result. The mapping model is, for example, a fully connected layer.

In some embodiments, the second mapping model is used to process the data to be predicted to determine the prediction result. The determination method of the second mapping model, for example, refers to the previous embodiment, and will not be described here.

In step S406, whether to recommend the alternative article to the target user is determined according to the prediction result of the data to be predicted.

In some embodiments, the prediction result is used as the input of the post-ranking algorithm to obtain a recommendation result. For example, a reference ranking of the prediction result of the data to be predicted in prediction results corresponding to all articles in the alternative article set is determined; and the alternative article is recommended to the target user in response to the reference ranking being higher than a predefined ranking.

FIG. 5 shows a schematic diagram of a data processing process at the time of prediction. As shown in FIG. 5, features of a user and an article are jointly input into the recommendation model, to obtain a category-independent representation and a category-dependent representation output by the recommendation model, and then obtain a prediction result according to these two representations.

In the above embodiment, when the recommendation model outputs the representation, it separates the category-independent representation from the category-dependent representation, and makes recommendation based on the separated representations, thus improving the recommendation diversity and accuracy of the recommendation model at the same time.

In some embodiments, the aforementioned training method and recommendation method can be executed on a server. When making recommendation, the server can send the data corresponding to the determined articles recommended for the user to the user's terminal device, so that the terminal device can show the recommendation result to the user.

It can be understood that before using the technical solutions disclosed in various embodiments of the present disclosure, users should be informed of the type, scope of use, usage scenarios, etc. of the information involved in the present disclosure in an appropriate way in accordance with relevant laws and regulations and authorization from users shall be obtained.

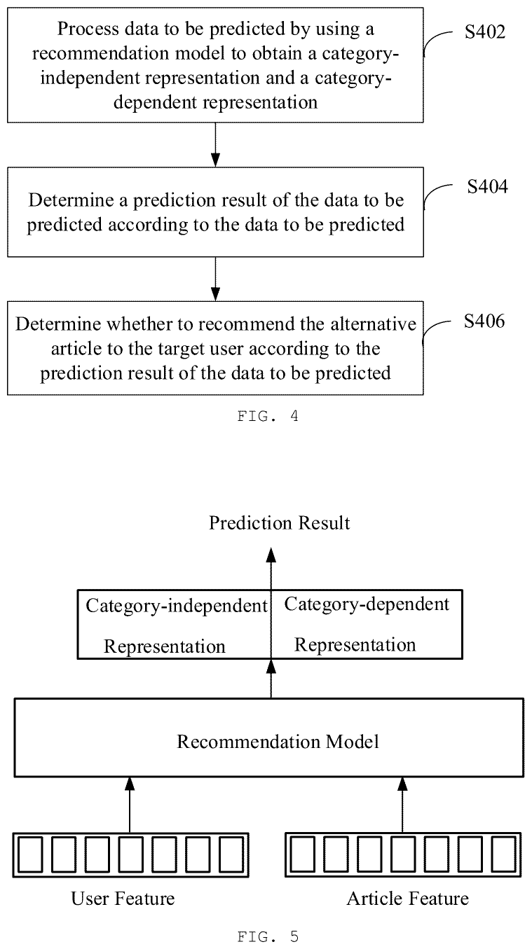

FIG. 6 shows a schematic structural diagram of a training device of a recommendation model according to some embodiments of the present disclosure. As shown in FIG. 6, the training apparatus 600 of this embodiment includes a representation acquisition module 6100 configured to process data for training by using a recommendation model to obtain a category-independent representation and a category-dependent representation, wherein the data for training comprises a feature of a user and a feature of an article, and is pre-marked with recommendation information and a category of the article; a discrimination module 6200 configured to process the category-independent representation and the category-dependent representation respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories; a prediction module 6300 configured to determine a prediction result according to at least one of the category-independent representation or the category-dependent representation; a training module 6400 configured to train the recommendation model and the discriminator according to training targets comprising the category-independent representation not corresponding to any one of the plurality of categories, the category-dependent representation corresponding to the pre-marked category, and the prediction result matching with the pre-marked recommendation information.

In some embodiments, a discrimination result of the discriminator has a plurality of dimensions corresponding one-to-one to the plurality of categories, and a value of each dimension of the dimensions represents a probability that a representation processed by the discriminator is related to a category corresponding to the dimension.

In some embodiments, the training module 6400 is further configured to a first loss value according to the discrimination results corresponding to the category-independent representation from the discriminator and a category-independent target result, wherein a value of each dimension in the category-independent target result is lower than a low threshold; and adjust parameters of the recommendation model and parameters of the discriminator based on the first loss value.

In some embodiments, the prediction module 6300 is further configured to process the category-independent representation by using a first mapping model to obtain a first prediction result; the training module 6400 is further configured to determine a second loss value according to the first prediction result and the pre-marked recommendation information to adjust the parameters of the recommendation model, the parameters of the discriminator and parameters of the first mapping model based on the first loss value and the second loss value.

In some embodiments, the training module 6400 is further configured to determine a third loss value according to the discrimination result of the category-dependent representation from the discriminator and a category-dependent target result, wherein in the category-dependent target result, a value of a dimension corresponding to a pre-marked category is higher than a high threshold, and values of other dimensions are lower than a low threshold; and adjust parameters of the recommendation model and parameters of the discriminator based on the third loss value.

In some embodiments, the prediction module 6300 is further configured to process the category-independent representation and the category-dependent representation by using a second mapping model to obtain a second prediction result; the training module 6400 is further configured to determine a fourth loss value according to the second prediction result and the pre-marked recommendation information to adjust the parameters of the recommendation model, the parameters of the discriminator and parameters of the second mapping model base on the third loss value and the fourth loss value.

In some embodiments, the training module 6400 is further configured to, in a process of adjusting the parameters of the recommendation model, keep the parameters of the discriminator and the parameters of second mapping model, a value of the category-independent representation constant.

In some embodiments, the recommendation information indicates whether feedback on the article is given by the user.

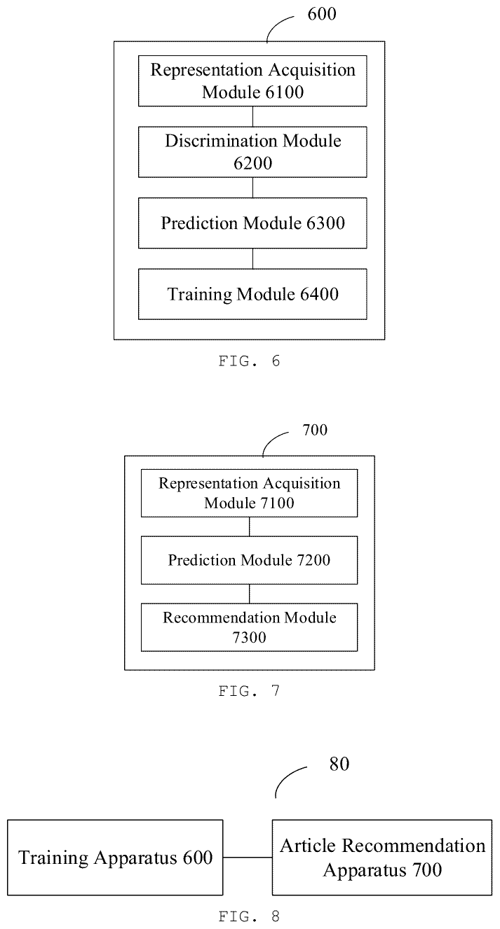

FIG. 7 shows a structural schematic diagram of an article recommendation apparatus according to some embodiments of the present disclosure. As shown in FIG. 7, the article recommendation apparatus 700 of this embodiment comprises: a representation acquisition module 7100 configured to process data to be predicted by using a recommendation model to obtain a category-independent representation and a category-dependent representation, wherein the data to be predicted comprises a feature of a target user and a feature of an alternative article; a prediction module 7200 configured to determine a prediction result of the data to be predicted according to the category-independent representation and the category-dependent representation in the data to be predicted; a recommendation module 7300 configured to determine whether to recommend the alternative article to the target user according to the prediction result of the data to be predicted.

In some embodiments, the alternative article is in an alternative article set, and the recommendation module 7300 is further configured to determine a reference ranking of the prediction result of the data to be predicted in prediction results corresponding to all articles in the alternative article set; recommend the alternative article to the target user in response to the reference ranking being higher than a predefined ranking.

In some embodiments, the recommendation model is trained by the training apparatus 600 of any of the aforementioned recommendation models.

In some embodiments, the representation acquisition module 6100 and the representation acquisition module 7100 may be the same module; the prediction module 6300 and the prediction module 7200 may be the same module.

FIG. 8 shows a structural schematic diagram of an article recommendation system according to some embodiments of the present disclosure. As shown in FIG. 8, article recommendation system 80 of this embodiment includes a training apparatus 600 of the recommendation model and an article recommendation apparatus 700.

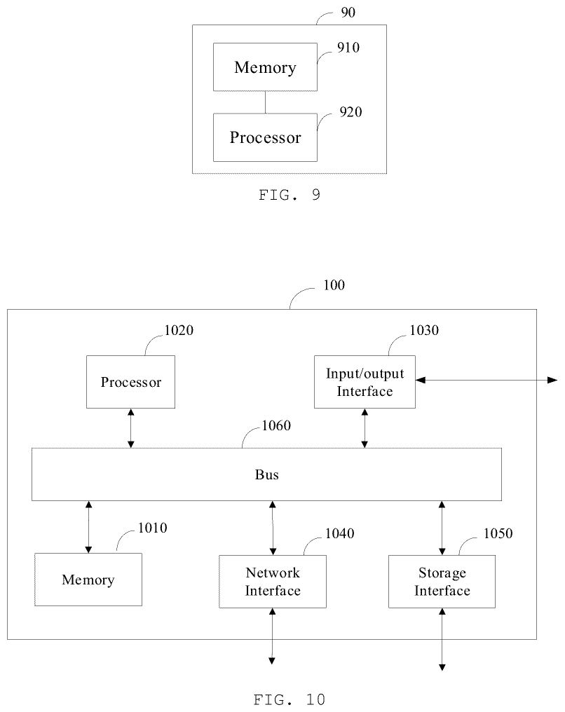

FIG. 9 shows a structural schematic diagram of an electronic device according to other embodiments of the present disclosure. As shown in FIG. 9, electronic device 90 of this embodiment includes a memory 910 and a processor 920 coupled to the memory 910, and the processor 920 is configured to execute the method in any of the aforementioned embodiments based on instructions stored in the memory 910.

The memory 910 may include, for example, a system memory, a fixed nonvolatile storage medium, and the like. The system memory stores, for example, an operating system, an application program, a Boot Loader and other programs.

FIG. 10 shows a structural schematic diagram of an electronic device according to other embodiments of the present disclosure. As shown in FIG. 10, electronic device 100 of this embodiment includes a memory 1010 and a processor 1020, and an input-output interface 1030, a network interface 1040, a storage interface 1050, and the like. These interfaces 1030, 1040, 1050 and the memory 1010 and the processor 1020 can be connected by a bus 1060, for example. The input-output interface 1030 provides a connection interface for input-output devices such as a display, a mouse, a keyboard and a touch screen. The network interface 1040 provides a connection interface for various networked devices. The storage interface 1050 provides a connection interface for external storage devices such as a SD card and a USB flash drive.

The embodiment of the present disclosure also provides a non-transitory computer-readable storage medium, on which a computer program is stored, characterized in that the program, when executed by a processor, implements any one of the aforementioned methods.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Furthermore, the present disclosure may take the form of a computer program product embodied on one or more computer-usable non-transitory storage media (including but not limited to disk storage, CD-ROM, optical storage, etc.) containing computer-usable program codes.

The present disclosure is described with reference to flow diagrams and/or block diagrams of methods, apparatuses (systems), and computer program products according to embodiments of the present disclosure. It should be understood that each flow and/or block in the flow diagrams and/or block diagrams, and combinations of the flow and/or block in the flow diagrams and/or block diagrams can be realized by computer program instructions. These computer program instructions may be provided to a processor of a general-purpose computer, special-purpose computer, embedded processor or other programmable data processing apparatus to produce a machine, such that the instructions executed by the processor of the computer or other programmable data processing apparatuses produce a means for implementing functions specified in one or more flows of a flow diagram and/or one or more blocks of the block diagram.

These computer program instructions may also be stored in a computer-readable memory capable of directing a computer or other programmable data processing apparatus to function in a particular manner, such that the instructions stored in the computer-readable memory produce a manufacture including instruction means that implements the functions specified in one or more flows of the flow diagram and/or one or more blocks of the block diagram.

These computer program instructions may also be loaded onto a computer or other programmable data processing apparatuses, such that a series of operational steps are performed on the computer or other programmable apparatuses to produce a computer-implemented process, such that the instructions executed on the computer or other programmable apparatuses provide steps for implementing the functions specified in one or more flows of the flow diagram and/or one or more blocks of the block diagram.

The above is only the preferred embodiments of this disclosure, and is not intended to limit this disclosure. Any modification, equivalent substitution, improvement, etc. made within the spirit and principle of this disclosure should be included in the protection scope of this disclosure.

What is claimed is:

1. A training method of a recommendation model, comprising:
processing data for training by using a recommendation model to obtain a category-independent representation and a category-dependent representation, wherein the data for training comprises a feature of a user and a feature of an article, and is pre-marked with recommendation information and a category of the article;
processing the category-independent representation and the category-dependent representation respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories;
determining a prediction result according to at least one of the category-independent representation or the category-dependent representation; and
training the recommendation model and the discriminator according to training targets comprising the category-independent representation not corresponding to any one of the plurality of categories, the category-dependent representation corresponding to the pre-marked category, and the prediction result matching with the pre-marked recommendation information.

2. The training method according to claim 1, wherein a discrimination result of the discriminator has a plurality of dimensions corresponding one-to-one to the plurality of categories, and a value of each dimension of the dimensions represents a probability that a representation processed by the discriminator is related to a category corresponding to the dimension.

3. The training method according to claim 2, wherein the training the recommendation model and the discriminator comprises:
determining a first loss value according to the discrimination results corresponding to the category-independent representation from the discriminator and a category-independent target result, wherein a value of each dimension in the category-independent target result is lower than a low threshold; and
adjusting parameters of the recommendation model and parameters of the discriminator based on the first loss value.

4. The training method according to claim 3, wherein:
the determining the prediction result comprises processing the category-independent representation by using a first mapping model to obtain a first prediction result; and
the training the recommendation model and the discriminator further comprises:
determining a second loss value according to the first prediction result and the pre-marked recommendation information to adjust the parameters of the recommendation model, the parameters of the discriminator and parameters of the first mapping model based on the first loss value and the second loss value.

5. The training method according to claim 2, wherein the training the recommendation model and the discriminator comprises:
determining a third loss value according to the discrimination result of the category-dependent representation from the discriminator and a category-dependent target result, wherein in the category-dependent target result, a value of a dimension corresponding to a pre-marked category is higher than a high threshold, and values of other dimensions are lower than a low threshold; and
adjusting parameters of the recommendation model and parameters of the discriminator based on the third loss value.

6. The training method according to claim 5, wherein:
the determining a prediction result comprises processing the category-independent representation and the category-dependent representation by using a second mapping model to obtain a second prediction result; and
the training the recommendation model and the discriminator further comprises:
determining a fourth loss value according to the second prediction result and the pre-marked recommendation information to adjust the parameters of the recommendation model, the parameters of the discriminator and parameters of the second mapping model based on the third loss value and the fourth loss value.

7. The training method according to claim 6, wherein in a process of adjusting the parameters of the recommendation model, the parameters of the discriminator and the parameters of second mapping model, a value of the category-independent representation is kept constant.

8. The training method according to claim 1, wherein the recommendation information indicates whether feedback on the article is given by the user.

9. An article recommendation method, comprising:
processing data to be predicted by using a recommendation model to obtain a category-independent representation and a category-dependent representation, wherein the data to be predicted comprises a feature of a target user and a feature of an alternative article;
determining a prediction result of the data to be predicted according to the data to be predicted; and
determining whether to recommend the alternative article to the target user according to the prediction result of the data to be predicted.

10. The article recommendation method according to claim 9, wherein the alternative article is in an alternative article set, and the determining whether to recommend the alternative article to the target user comprises:
determining a reference ranking of the prediction result of the data to be predicted in prediction results corresponding to all articles in the alternative article set; and
recommending the alternative article to the target user in response to the reference ranking being higher than a predefined ranking.

11. The article recommendation method of claim 9, further comprising:
processing data for training by using the recommendation model to obtain a category-independent representation and a category-dependent representation, wherein the data for training comprises a feature of a user and a feature of an article, and is pre-marked with recommendation information and a category of the article;
processing the category-independent representation and the category-dependent representation respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories;
determining a prediction result according to at least one of the category-independent representation or the category-dependent representation; and
training the recommendation model and the discriminator according to training targets comprising the category-independent representation not corresponding to any one of the plurality of categories, the category-dependent representation corresponding to the pre-marked category, and the prediction result matching with the pre-marked recommendation information.

12. A training apparatus of a recommendation model, comprising:
a memory; and
a processor coupled to the memory, the processor configured to, based on instructions stored in the memory, perform a training method comprising:
processing data for training by using a recommendation model to obtain a category-independent representation and a category-dependent representation, wherein the data for training comprises a feature of a user and a feature of an article, and is pre-marked with recommendation information and a category of the article;
processing the category-independent representation and the category-dependent representation respectively by using a discriminator to obtain: a discrimination result corresponding to the category-independent representation indicating a correlation between the category-independent representation processed by the discriminator and a plurality of categories, and a discrimination result corresponding to the category-dependent representation indicating a correlation between the category-dependent representation processed by the discriminator and the plurality of categories;
determining a prediction result according to at least one of the category-independent representation or the category-dependent representation; and
training the recommendation model and the discriminator according to training targets comprising the category-independent representation not corresponding to any one of the plurality of categories, the category-dependent representation corresponding to the pre-marked category, and the prediction result matching with the pre-marked recommendation information.

13. The training apparatus according to claim 12, wherein a discrimination result of the discriminator has a plurality of dimensions corresponding one-to-one to the plurality of categories, and a value of each dimension of the dimensions represents a probability that a representation processed by the discriminator is related to a category corresponding to the dimension.

14. The training apparatus according to claim 13, wherein the training the recommendation model and the discriminator comprises:
determining a first loss value according to the discrimination results corresponding to the category-independent representation from the discriminator and a category-independent target result, wherein a value of each dimension in the category-independent target result is lower than a low threshold; and
adjusting parameters of the recommendation model and parameters of the discriminator based on the first loss value.

15. The training apparatus according to claim 14, wherein:
the determining the prediction result comprises processing the category-independent representation by using a first mapping model to obtain a first prediction result; and
the training the recommendation model and the discriminator further comprises:
determining a second loss value according to the first prediction result and the pre-marked recommendation information to adjust the parameters of the recommendation model, the parameters of the discriminator and parameters of the first mapping model based on the first loss value and the second loss value.

16. The training apparatus according to claim 13, wherein the training the recommendation model and the discriminator comprises:
determining a third loss value according to the discrimination result of the category-dependent representation from the discriminator and a category-dependent target result, wherein in the category-dependent target result, a value of a dimension corresponding to a pre-marked category is higher than a high threshold, and values of other dimensions are lower than a low threshold; and
adjusting parameters of the recommendation model and parameters of the discriminator based on the third loss value.

17. An article recommending apparatus, comprising:
a memory; and
a processor coupled to the memory, the processor configured to, based on instructions stored in the memory, perform the article recommendation method according to claim 9.

18. An article recommendation system, comprising:
the training apparatus of the recommendation model of claim 12; and,
an article recommendation apparatus comprising:
a memory; and
a processor coupled to the memory, the processor configured to, based on instructions stored in the memory, perform an article recommendation method comprising:
processing data to be predicted by using a recommendation model to obtain a category-independent representation and a category-dependent representation, wherein the data to be predicted comprises a feature of a target user and a feature of an alternative article;
determining a prediction result of the data to be predicted according to the data to be predicted; and
determining whether to recommend the alternative article to the target user according to the prediction result of the data to be predicted.

19. A non-transitory computer-readable storage medium having stored thereon a computer program which, when executed by a processor, implements the training method according to claim 1.

20. A non-transitory computer-readable storage medium having stored thereon a computer program which, when executed by a processor, implements the article recommendation method according to claim 9.
